(19) United States
(12) Patent Application Publication
(10) Pub. No.: US 2010/0042605 A1
(43) Pub. Date: Feb. 18, 2010

(54) VERSIONING RELATIONAL DATABASE DISJOINT RECORDS

(75) Inventors: Yuu-heng Cheng, Piscataway, NJ (US); Alexander Poylisher, Brooklyn, NY (US); Aditya Naidu, Edison, NJ (US); Rajesh Talpade, Madison, NJ (US); Shrirang Gadgil, Eatontown, NJ (US)

Correspondence Address: TELCORDIA TECHNOLOGIES, INC., ONE TELCORDIA DRIVE 5G116, PISCATAWAY, NJ, 08854-4157, US

(73) Assignee: Telcordia Technologies, Inc., Piscataway, NJ (US)

(21) Appl. No.: 12/533,676

(22) Filed: Jul. 31, 2009

Related U.S. Application Data
(60) Provisional application No. 61/085,143, filed on Jul. 31, 2008.

(51) Int. Cl. G06F 17/30; G06F 12/00

(52) U.S. Cl. 707/4; 707/203; 707/100; 707/E17.045

(57) ABSTRACT

An inventive system and method for versioning relational database disjoint records comprises a relational database, configuration files translated into query files, and a version control system, wherein each query file is stored and checked into the version control system, updating a version number of the query file. Each query file comprises a set of query statements. Query files are retrieved from the version control system based on the version number or an independent data item, and put into the database for analysis. In one embodiment, one of the configuration files comprises a configuration of a device, such as a router, a switch, a firewall, or a medical record. The method comprises acquiring configuration files, changing the configuration files into query files and storing the query files, and checking each query file into a version control system, wherein the checking in updates a version number of the query file.

### CROSS REFERENCE TO RELATED APPLICATIONS

The present invention claims the benefit of U.S. provisional patent application 61/085,143 filed Jul. 31, 2008, the entire contents and disclosure of which are incorporated herein by reference as if fully set forth herein.

### FIELD OF THE INVENTION

The present invention relates generally to relational database management systems.

### BACKGROUND OF THE INVENTION

In network configuration analysis, network configuration is represented as a set of device configurations, for devices such as routers, switches, firewalls, etc. Network-wide configuration analysis needs to query relationships between devices. Structured Query Language (SQL) provides an efficient and standard mechanism for information query. To take advantage of this mechanism, device configurations need to be represented in SQL tables.

Moreover, each device configuration has an independent change history that can be represented as a sequence of snapshots. A network state is given by a set of arbitrary snapshots of constituent device configurations. In order to recover a specific network state for analysis, a mechanism for independent retrieval of a device configuration snapshot and subsequent combination of the retrieved snapshots into a single network state representation is needed.

On the one hand, relational database management systems (RDBMS) support SQL queries. The typical usage of RDBMS is for persistent storage. Therefore, the backup and recovery is performed at the granularity of the entire database. This by itself is not sufficient for network configuration analysis. It does not provide the flexibility of independent retrieval of different snapshots of device configuration. On the other hand, a version control system (VCS) can provide independent retrieval of device configuration snapshots. The change history is stored in deltas, which saves disk space. However, a VCS does not support any querying mechanism for cross device relationships.

There is a need for a system that combines the functionality of SQL query support with retrieval of a set of independent snapshots.

### SUMMARY OF THE INVENTION

An inventive system and method of versioned storage of database recordsets is presented. Each recordset can be represented as SQL insert statements in a file stored in a VCS. Other recordsets, such as medical data, employee information, etc., can also be used. This approach of storing files in a VCS allows retrieval of a set of independent snapshots into an RDBMS, enabling a set of disjoint relations to be versioned independently.

The inventive system and method for versioning relational database disjoint records comprises a relational database, one or more query files, one or more configuration files, each configuration file translated into a query file, and a version control system, wherein each query file is stored and checked into the version control system, updating a version number of the query file. In one embodiment, the query file comprises a set of query statements, e.g., SQL INSERT statements. The query file is retrieved from the version control system based on the version number or an independent data item, and the retrieved query file is analyzed. In one embodiment, one of the configuration files comprises a configuration of a device, such as a router, a switch, a firewall, or a medical record. The method comprises acquiring configuration files, combining or translating the configuration files into one or more query files and storing each query file, and checking the query file into a version control system, wherein the checking in updates a version number of the query file.

Translating the files into a query file, such as a set of INSERT statements, reduces the time for preparing the file, i.e., checking out the file and inserting it into RDBMS, for analysis. However, if the files are already in a SQL format, e.g. medical records that are already stored in a DB, then there is no translation required.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 depicts a snapshot of the network that constitutes different devices;

FIG. 2 depicts an inter-table relationship of an individual device;

FIG. 3 depicts versioning of the device configuration of the device of FIG. 2;

FIG. 4 depicts combining device configurations; and

FIG. 5 depicts a schematic diagram of components of the inventive system.

### DETAILED DESCRIPTION

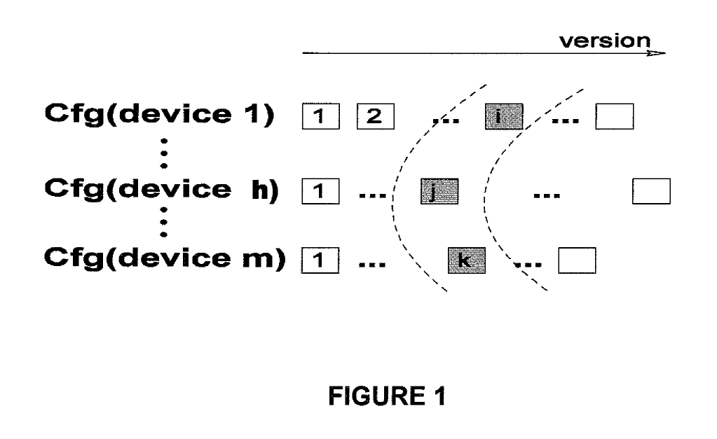

An inventive system and method of versioned storage of database recordsets includes recordsets represented as SQL insert statements in a file stored in a VCS, so that retrieval of a set of independent snapshots into an RDBMS can be performed, enabling a set of disjoint relations to be versioned independently. In other words, a snapshot illustrating device l, version i and device h, version j can easily be retrieved and viewed. An example of a snapshot of a network according to the inventive system and method is depicted in FIG. 1. The devices l, h, and m are in the versions of i, j, and k, respectively. In particular, the configuration data describing device l is data reflecting version i or the i^{th} version of this device. Similarly, device h is described in accordance with the configuration of this device in its j^{th} version, and device m is described in accordance with its k^{th} version. This snapshot can be identified by VCS “tagging” mechanism or by storing the information in a separate file.

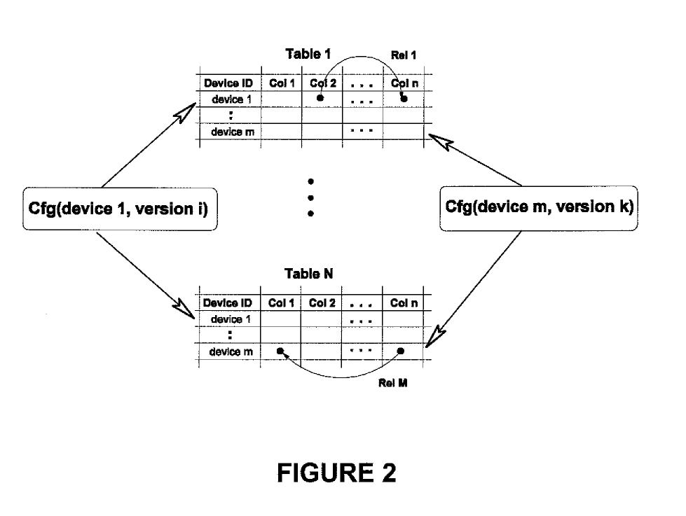

FIG. 2 illustrates the “checked out” snapshot corresponding to the information in FIG. 1, as stored into the RDBMS. Table 1 through Table N are correlated via the device ID or other identifiers typically used in SQL. As shown in FIG. 2, each table (l through N) contains the device ID and entries into the appropriate column(s) indicating the existence of a version of the device. The RDBMS tables are loaded with version i from device l and version k from device m. The time relationship between device l and device m can be broken. Traditionally the RDBMS, when backing up the whole database, keeps the time relationship intact.

Thus, the relationship between device l and device m can be analyzed. The relationship within one device is implicitly indicated by, e.g. device l column 2 has a relationship with column n, i.e. Rel 1 in Table 1; device m column n has a relationship with column 1 in Table N. Thus a snapshot of both devices l and m can be created in accordance with column n.

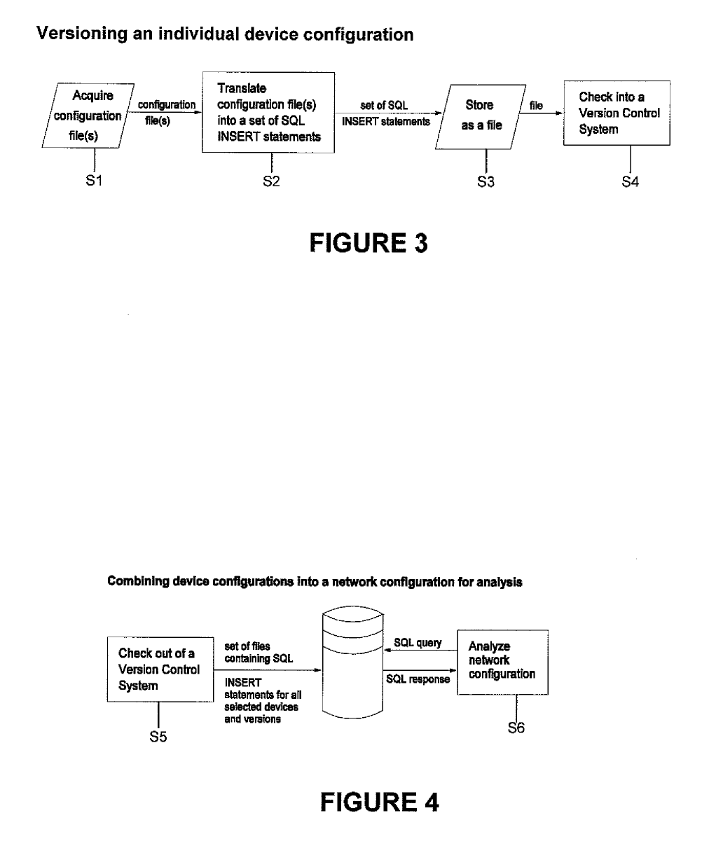

FIG. 3 illustrates the process flow for one device configuration. In step S1, one or more configuration files are acquired. In step S2, each device configuration obtained from the network is passed to a component that translates configuration file(s) into a set of SQL insert statements, described below. In step S3, the set of SQL insert statements are stored as a file, e.g., an SQL file for a device. In step S4, the file, e.g., SQL file, is checked into a VCS as the same source, that is, the file is checked in or saved in the VCS as the next version of that device. Accordingly, as is typical with a VCS, the first time a file is created for a device, it is checked in or stored in the VCS as version 1. The next time a file is created for the same device, it is checked in to the VCS as version 2, and each time the file for the same device is checked in, the VCS increments the version number. Steps S1 through S4 are repeated as needed to maintain up-to-date device configuration information in the VCS.

A way for identifying to the VCS that the output SQL file for a device is to be correlated with prior versions of this file is an inventive feature. For some VCS, such as Concurrent Versions System (CVS), the versioning of the file for the same device requires the output filename for this same device to always be the same. For other VCS, such as Subversion (SVN), the corresponding old entry needs to perform “svn move” to the new name and needs to be checked in before checking in the file with new name. Moreover, the original device configuration file can be optionally stored together if required.

When the configuration files are stored and maintained in a VCS with the appropriate version, the corresponding configuration set can be retrieved for network configuration analysis as shown in FIG. 4. In step S5, a specific version of the configuration is retrieved or “checked out” from the VCS and loaded into the relational database (an RDBMS). One or more configurations can be checked out, such as only device m version k, or device l version i along with device m version k, or device l version i, device h version j, and device version k, or any appropriate combination of device(s) and/or version(s). In step S6, the network configuration analyzer can analyze the network of a specific state.

The translation of configuration file(s) into a set of SQL INSERT statements, step S2 in FIG. 3, proceeds as follows. If the database schema does not contain any automatic assigned database fields, such as auto increment fields, the translation from configuration file to the SQL insertion is trivial. However, when an automatic assigned database field is used as a relationship key between tables, then the SQL insert statements are not as straightforward. In order to allow arbitrary retrieval of configuration files from the VCS, these files should be inserted into the DB with the correct relationship references, so that the insert statements file should contain corresponding reference SQL statements. For example, assume there are a Device table and an Interface table. The Device table has the following columns: idDevice, hostname, and vendor. The Interface table has the columns; idnterface, idDevice, intf_name, and ip_address. The insertion statement for the idDevice column in the Interface table will have to depend on the result of the Device table insertion. This can be resolved by adding a sub-query in the insertion statement. In order to increase the performance, the sub-query can be changed to a SQL variable. This reduces the number of subsequent queries for inserting multiple interfaces.

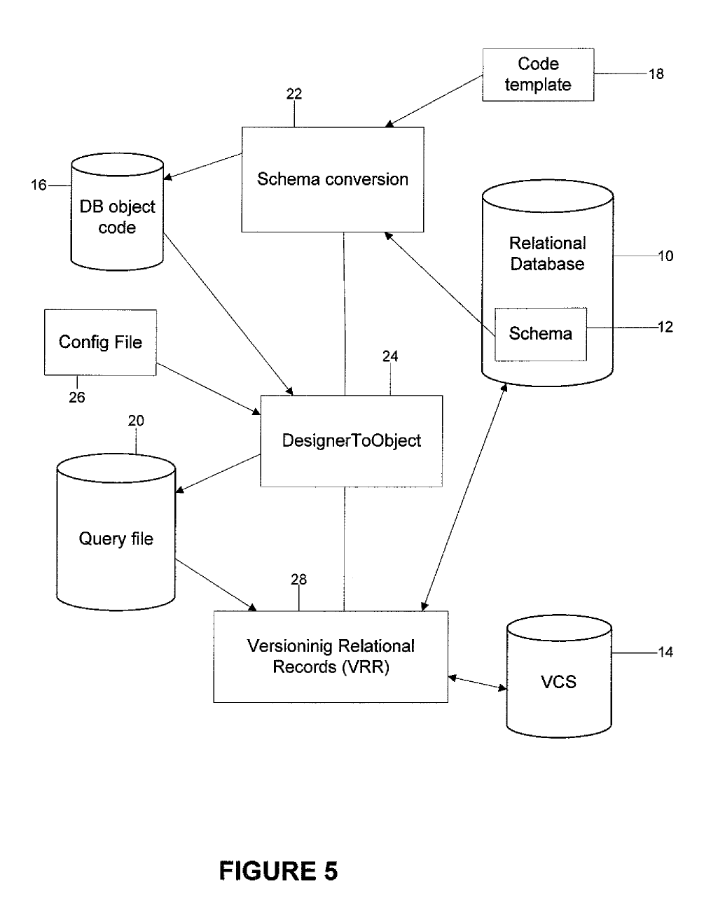

FIG. 5 is a schematic diagram including the relational database 10 and its schema 12, as well as the VCS 14. For example, an API can be created to automatically generate the SQL insert statements file via automatic generated DB objects from the SQL schema file. This API first generates the DB object code 16 from the schema file 12 and code template 18. Then the DB object 16 contains the corresponding methods to generate the corresponding SQL insert statements in an SQL or query file 20 when needed. Details of these two steps are described below.

First, the schema design can be converted to DB objects 16. One component, Schema Conversion 22 takes a schema design file 12 with the following conventions: (1) each Table contains a key that identifies the record; (2) all related records are linked with foreign key relationship; and (3) the table relationships can be transformed into a tree, where the root node auto increment ID appears in all tables. (4) A separate file can be provided for relations to exclude.

The DB objects 16 are designed as follows. Objects that are foreign primary key are constructed. Each object contains a restricted amount of attributes that can be set with type checking and an array of relationships. Each object can be a referenced relation by only one other object. When creating a new instance of any object, there will be a global unique identifier.

A DesignerToObject component 24 converts the object codes 16 combined with the configuration file 26 into SQL insert statements in query file 20, step S3 in FIG. 3. Configuration files, which can contain more than one device, are parsed into the DB objects. If the configuration file 26 contains only one device, one DB object 16 is created. However, if the configuration file 26 contains more than one device, a DB object 16 for each device is created. Each of the DB objects 16 can be converted to SQL insert statements as follows. Columns without any reference can be directly inserted while columns that include a foreign key are inserted with an SQL reference variable. After each insertion, the auto-increment ID will be set as a SQL variable for later reference. In another embodiment, instead of using the auto-increment ID, a unique key can be specified to replace the select statements. In one embodiment, foreign keys are referenced within the DB object 16.

The SQL or query file 20 containing the SQL insertion statements and a set of the device meta data is passed to the Versioning Relational Records (VRR) module 28. The module can optionally store the meta data in the database 10, and put the SQL file 20 into the file-based VCS 14, step S4 in FIG. 3.

The device meta data allows the user to find the corresponding devices to load using SQL query. Optionally a system can store these meta data in other formats. The user can also select different versions. Once the version is selected, the VRR 28 will check out the device SQL file from the VCS 14 and load the SQL file 20 into the database 10, step S5 in FIG. 4. To unload a specific device, the VRR 28 can delete all records that contain the corresponding reference relationship to that device. In the alternative, VRR 28 can load back the SQL file 20 as a checked in file if there are modifications.

One embodiment of the inventive system is a passive network validation system that incorporates a cross-technology and cross-vendor network configuration model. The system combines first order logic (FOL), database technology and graph algorithms to enable rapid implementation of efficient validation suites. The inventive system is implemented using a relational database.

In one embodiment, the relational database is used to store network device configuration across the following technologies: VLAN, IPSec, access control lists, static routing, OSPF, RIP, HSRP, and QoS. The device vendors can include Cisco (IOS), Juniper (ScreenOS), CheckPoint (FW-1), and Nokia (VPN Gateway). In this embodiment, the inventive system can contain validation suites for basic reachability, security, fault tolerance, and performance (QoS). However, the inventive system is not limited to these technologies and/or device vendors, and can employ others as appropriate.

An SQL database schema is a good optimization for implementing a well-known model. In one embodiment, MySQL 5.0 can be used. Advantages of implementing the inventive network configuration model in a relational database include the following. The relational database advantageously provides graph relationships, since not all device configuration information can be specified as purely tree-structured. For example, in VLANs, a network port has multiple VLAN identifiers when it is configured as a trunk port. On the other hand, multiple network ports can belong to the same VLAN. The relational database can implement a simplified CLM model that focuses on network device routing functionalities and filtering functionalities.

Further, optimized data manipulation and/or search operation is available using SQL in a relational database. SQL views simplify aggregation of the existing data. This feature can advantageously be used for analysis tools to be able to view the configuration in their own perspectives. In addition, a relational database supports referential integrity that maintains the basic relationships between different tables. Therefore, validators can focus on more complex relationship validations, including the modified relationships.

In another embodiment, the inventive system and method can be applied to medical records and information. In this embodiment, the medical records (devices) have independent data items such as time stamps, illnesses, symptoms, etc., so that information can be retrieved according to one of these data items. For example, “Bob” is a thirty-year-old who has medical history in a collection of medical records, and “Sue” is a fifty-year-old who also has medical history in medical records. If a correlation among all thirty-year-olds is desired, the inventive system can retrieve Bob's current records and Sue's records from twenty years ago as a collective view of information for further analysis. Similarly, the system can retrieve records of anyone having a symptom such as a fever or a rash, regardless of when the person had the symptom. Hence, the version, e.g., version number, can be considered a count or indicator for retrieving and analyzing data. The inventive system and method advantageously exploits the combination of version control and data retrieval by the system's unique storage and retrieval of information in a VCS. It is possible to create the VCS using a RDBMS.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for versioning relational database disjoint records, comprising:
a relational database;
one or more query files;
one or more configuration files, each configuration file translated into a query file of the one or more query files; and
a version control system, wherein each query file is stored and checked into the version control system, updating a version number of the query file.

2. The system according to claim 1, wherein each query file comprises a set of query statements.

3. The system according to claim 1, wherein any one or more of the query files are retrieved from the version control system based on the version number or an independent data item, and the retrieved query file is analyzed.

4. The system according to claim 1, wherein one of the configuration files comprises a configuration of a device.

5. The system according to claim 4, wherein the device is one of a router, a switch, a firewall, and a medical record.

6. A method for versioning relational database disjoint records, comprising steps of:
acquiring one or more configuration files;
translating the one or more configuration files into one or more query files and storing each query file; and
checking each query file into a version control system, wherein the checking in updates a version number of the query file.

7. The method according to claim 6, wherein each query file comprises a set of query statements.

8. The method according to claim 6, further comprising the steps of:
retrieving any one or more query files from the version control system based on the version number or an independent data item; and
analyzing the retrieved query file.

9. The method according to claim 6, wherein one of the configuration files comprises a configuration of a device.

10. The method according to claim 9, wherein the device is one of a router, a switch, a firewall, and a medical record.

11. A computer readable medium having computer readable program for operating on a computer for versioning relational database disjoint records, said program comprising instructions that cause the computer to perform the steps of:
acquiring one or more configuration files;
translating the one or more configuration files into one or more query files and storing each query file; and
checking each query file into a version control system, wherein the checking in updates a version number of the query file.

12. The program according to claim 11, wherein each query file comprises a set of query statements.

13. The program according to claim 11, further comprising the steps of:
retrieving any one or more query files from the version control system based on the version number or an independent data item; and
analyzing the retrieved query file.

14. The program according to claim 11, wherein one of the configuration files comprises a configuration of a device.

15. The program according to claim 14, wherein the device is one of a router, a switch, a firewall, and a medical record.
